(19) United States
(12) Patent Application Publication
(10) Pub. No.: US 2008/0235766 A1
(43) Pub. Date: Sep. 25, 2008

(54) APPARATUS AND METHOD FOR DOCUMENT CERTIFICATION

(76) Inventors: Robert WALLOS, Katonah, NY (US); Stephen M. Cantor, West Hurley, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/849,513

(22) Filed: Sep. 4, 2007

Related U.S. Application Data
(60) Provisional application No. 60/824,292, filed on Sep. 1, 2006.

(51) Int. Cl. G06F 21/00

(52) U.S. Cl. 726/2

(57) ABSTRACT

A method and apparatus for authenticating documents is described. A document from a client is processed to determine if it is authentic and then tags are generated to indicate that a document is authentic or not. The tags can be added to the document before it is sent to a recipient. The document is also stored and made available to the sender, recipient or third party together with a certificate of authenticity.

### RELATED APPLICATIONS

This application claims priority to provisional application Ser. No. 60/824,292 filed Sep. 1, 2006 and incorporated herein by reference.

### BACKGROUND OF THE INVENTION

A. Field of Invention

This invention pertains to a method and apparatus that provides an automatic certification indicating that a document is received from the requested source.

B. Description of the Prior Art

In the present application, unless otherwise noted, the term ‘document’ is used generically to refer to a communication from a sender to a recipient, including an electronically transmitted communication that may include electronic file such as an e-mail, a fax, an IM message, and so on, as well as a physical or hard copy such as a letter transmitted by standard mails services, including surface and air mail, courier and messenger services and so on. The number of such communications has been increasing exponentially for a number of years. A significant portion of these communications require some assurance that the document was genuine and/or that it was sent and received by the correct parties. For physical documents or hard copies, historically, the carrier obtained some kind of acknowledgement that the document was received. The acknowledgement is delivered back to the sender. However, no validation or receipt for the documents' contents was obtained or stored.

Similarly, most e-mail providers and software provide some kind of message to the sender as to whether a recipient has received a message, and whether he has actually read it (or, more properly, an indication that the recipient has at least opened a message). However, with all the electronic mischief that is going on lately, neither the sender nor the recipient can be sure that either an electronic document or a message purporting to be an acknowledgment for the receipt of a message are genuine.

Therefore there is a real need for a system and method that can provide a secure, convenient and inexpensive means to insure both that a message and its contents are is genuine and that it has been delivered properly. Moreover, there is a need for a system that provides a means of independently storing the document so that it can be retrieved at a later date for legal activities, auditing and other similar activities.

### SUMMARY OF THE INVENTION

The present invention fulfills these needs by providing a system and method in which various forms of documents are tagged when sent to a recipient, with copies being stored for archival purposes. Tags are also added to the document to indicate when was the document delivered and (if possible), when was it read (or at least opened) by the recipient. The tags are also incorporated into the stored document.

### BRIEF DESCRIPTION OF THE DRAWINGS

FIG. 1A shows a block diagram of a system constructed in accordance with this invention;

FIG. 1B shows various fields stored by the system of FIG. 1A;

FIG. 2 shows a flow chart of the process used to authenticate e-mail with or without attachments;

FIG. 3 shows a flow chart of a process for authenticating faxes;

FIG. 4 shows a flow chart of a process for authenticating scanned documents;

FIG. 5 shows a flow chart of a process for authenticating IM messages;

FIG. 6 shows a flow chart similar to the one in FIG. 2 in which the payment means has been predetermined;

FIG. 7 shows a flow chart of how payment of is processed;

FIG. 8 shows a flow chart for authenticating a document generated by a web-based application;

FIG. 9 shows a flow chart for authenticating a shared document created;

FIG. 10 shows a flow chart of a process in which the authenticating includes a digital signature

FIG. 11 shows a flow chart for authenticating a document previously stored; and

FIG. 12 shows a sample of a document authentication letter.

### DESCRIPTION OF THE INVENTION

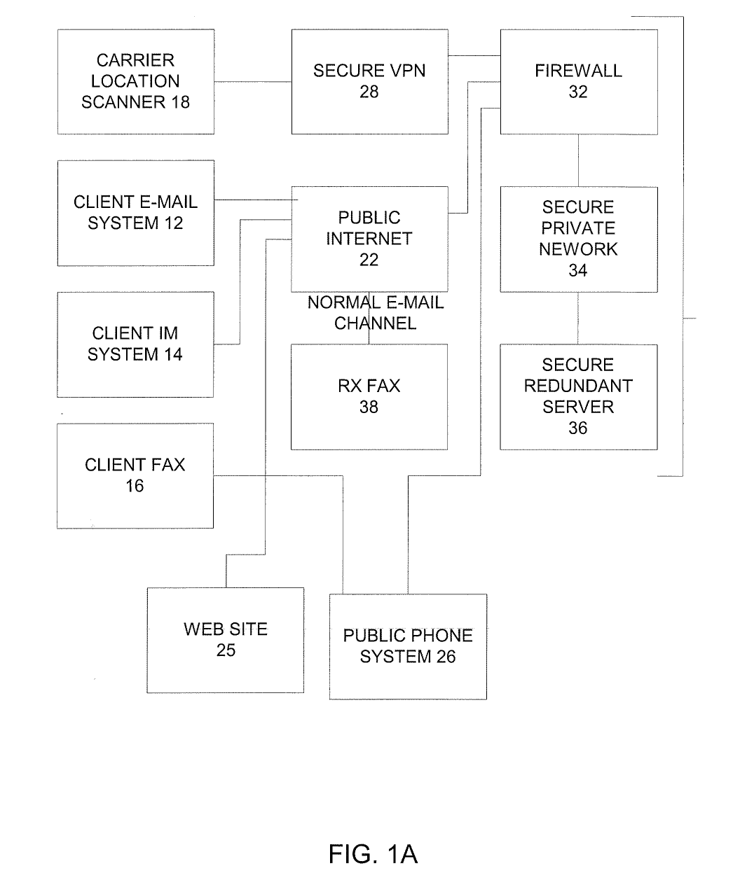

FIG. 1 shows the elements of a system 10 constructed in accordance with this invention. As indicated in this Figure, the source of document could be a client's PC 12 from which an e-mail or an IM message is sent to a recipient. Other sources of documents may be a laptop 14, fax machine 16, or a scanner 18. The documents from all or any these sources can be delivered to a recipient by well-known means that have been omitted from the drawings for the sake of clarity.

In addition, the documents are transmitted via a public Internet gateway 20, a public phone line 22, or secure line (when required) 24 to an offsite certification site 30 at a remote location. An intermediate public or private system 26, 28 is provided as means of connecting to the respective telephone lines 22, 24 as necessary. At the remote location the system includes a firewall 32, a secure private network 34 and a plurality of servers 36 used to generate authentication messages, as discussed below. In addition, the servers 36 also store the documents and the associated messages and tags. As also discussed below, the certification site also provides copies of the documents on request.

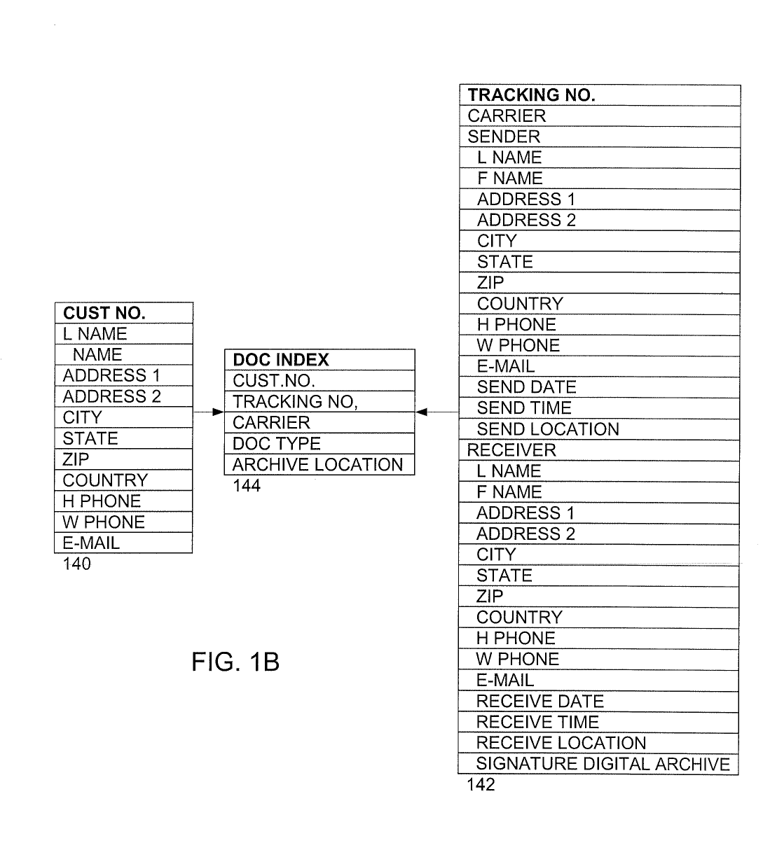

The operation of the system is best described in conjunction with an actual document transaction. FIG. 2 shows a flow chart for handling an outgoing e-mail message from a client connected to the system of FIG. 1A. In step 100 the client creates the e-mail with or without attachments. In step 102 the client decides whether the outgoing e-mail message should be certified or not. If no certification is required, the e-mail is sent off in the usual manner.

If certification is required, then in step 104 the client activates a corresponding control (such as an icon on the screen of his PC). Client is presented a login screen. He enters a username and password. The certification site 30 first checks whether the client is a bona fide client. If he is not then a warning is sent to the client rejecting the login. If he is recognized as a client, then a message is sent to the client indicating the total cost of certification transaction, identification details of the outgoing e-mail message, including sender, receiver, subject of the message, etc.

In step 110 the client makes a decision as to whether he wants to get certification or not. If he decides not to get certification, then outgoing message is sent out directly in the normal fashion. If the client decides to get certification, then in step 112 the certification performs a certification process. During this process, the original e-mail message is recorded in a database, together with various identification codes. FIG. 1B shows various data files stored in the servers 36, including a data file 140 of the various clients or customers, a file 142 with entries identifying the various transactions and a file 144 that is sent to the client as an acknowledgment that the message has been sent, and is certified. The message, including its text and identifiers are encrypted.

In step 114 the message (that may include file 144) is generated and sent to the client (step 115) confirming that the outgoing email message has been stored. In steps 116 and 118 the certification system attaches certification tags to the outgoing e-mail message and sends the thus certified e-mail message to the receiver through the client's own e-mail server.

In step 120 the recipient receives and retrieves the certified e-mail message. In step 122 a receipt indicating that the message was received and read is generated. The receipt is sent to the client and also stored by the certification system.

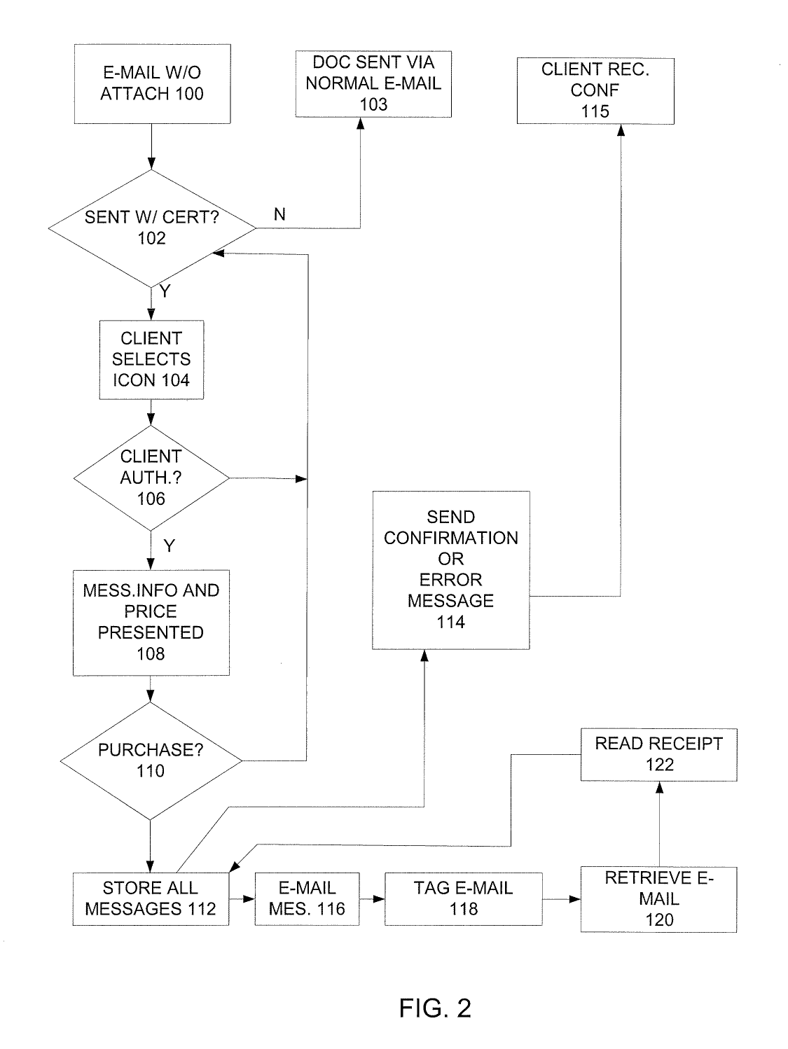

FIGS. 3-11 show how other types of documents are authenticated by system 10. The steps bearing the same numbers as the ones shown in FIG. 2 are not modified for the particular document being processed. For example, the process described above can be used with some minor modifications for authenticating faxes, as shown in FIG. 3. In this instance, the recipient receives a fax and the authentication tags include the fax transmission details. More specifically, in step 101 a fax is generated by PC 12, laptop 14 or fax machine 16. In step 105, an icon or other control element is activated on the fax machine to indicate that the user wants the fax authenticated. If necessary, the client also enters with login information in this step. In step 107 the client also enters the recipient's fax number. In step 109 a displays on the fax or elsewhere is used to show the costs of certification. In step 117 the receiving fax machine receives and displays an indication that a message with authentication is to be expected. In step 119 the receiver fax machine (38 on FIG. 1) returns to the user a signal indicating that it is ready to receive the message. In step 121 the fax is received. In step 123 the fax transmission details are recorded in the appropriate data bases (see FIG. 2) and a message is received by the sending fax indicating that the sent message was received and authenticated.

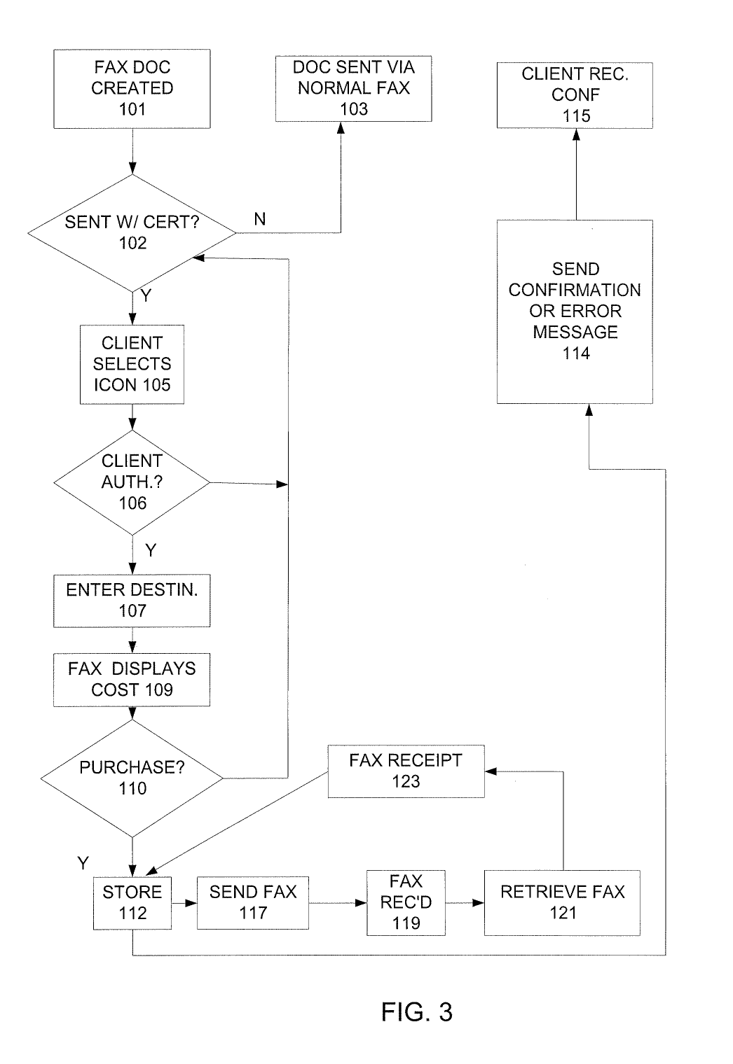

FIG. 4 shows how the process is modified for the transmission of hard copy documents. As shown in the Figure, the client first generates or obtains the hard copy (step 161). In step 102 the client decides whether he wants the document to be certified or not. If he does, he then takes or sends a copy of the document to an office associated with the authentication site (step 163). In step 164 the document is scanned. In step 165 a destination for the recipient is selected and entered. In step 166 postal labels are generated. In step 168 the parcel is sent to the recipient. In step 169 the parcel is received (for example from a courier). The recipient signs for the package (step 170) and a signal indicating that the document has been received.

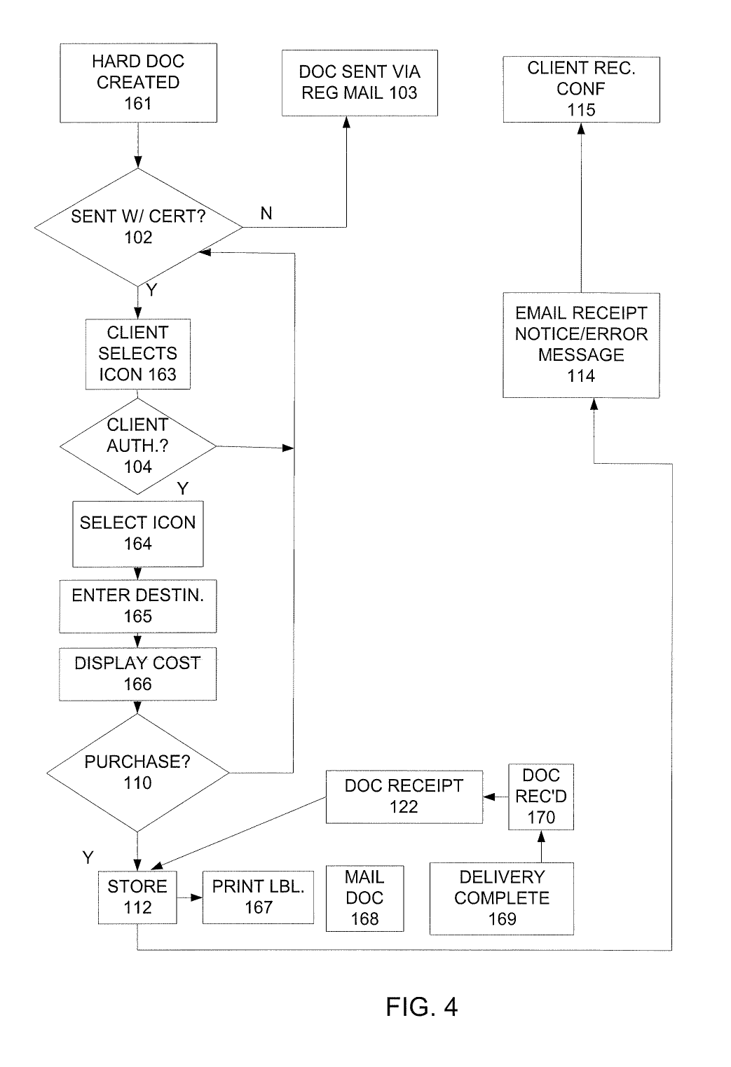

FIG. 5 shows how the process is modified for certifying an IM message. In step 172 the client initiates the IM session and decides whether he wants to authenticate the session or not. Normal IM session is conducted in step 173. In step 174 an icon is selected to initiate authentication. In step 175 authentication is performed. In step 176 the client invites a third party (or partner) to participate in an authenticated IM session and a minimal charge is initiated. In step 177 the IM session is conducted. At the end, the IM details are provided to the client and final charges are determined. In step 178 a determination is made as to whether authentication is purchased. In step 179 the IM text is stored together with any relevant details. In step 180 an e-mail is sent to the client with certification. This message is received in step 182.

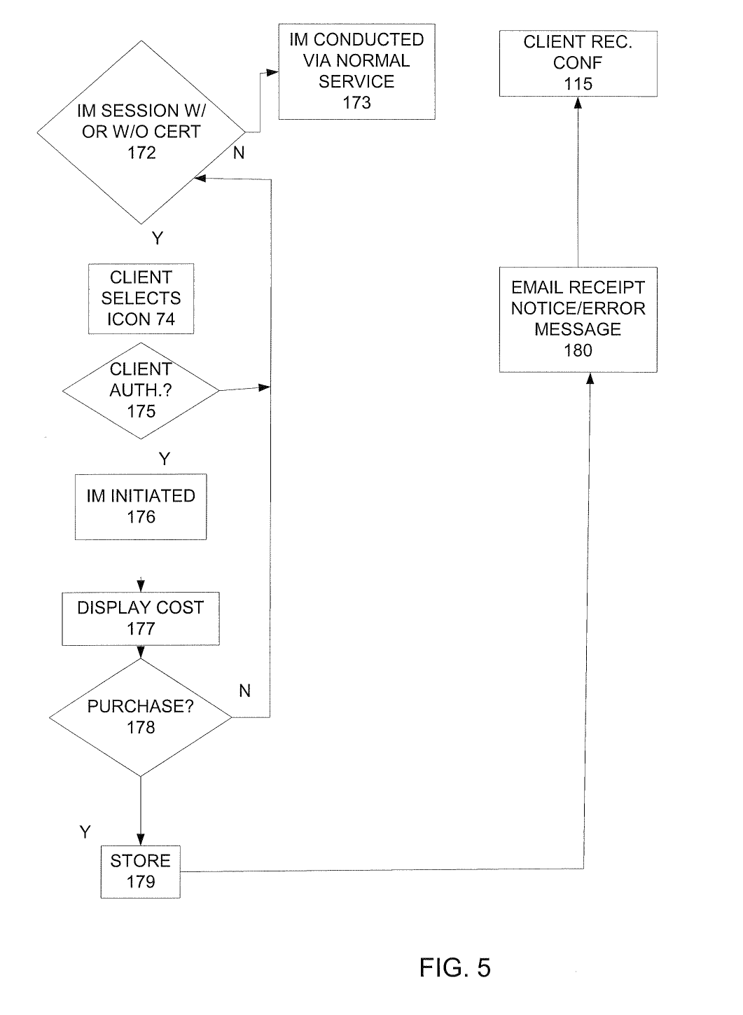

In FIG. 6, a process is shown that is very similar to the one in FIG. 2, except that the question of purchasing is determined before-hand. This feature is an option that may be selected by a client as part of his account profile. With this feature the client can accept the cost of transaction automatically and dispense with the necessity of approving the transaction for each e-mail sent. In other words, the client agree ahead of time that certification (when desired) is paid for the client/sender, the receiver, or some other third party and therefore step 110 is skipped in this process.

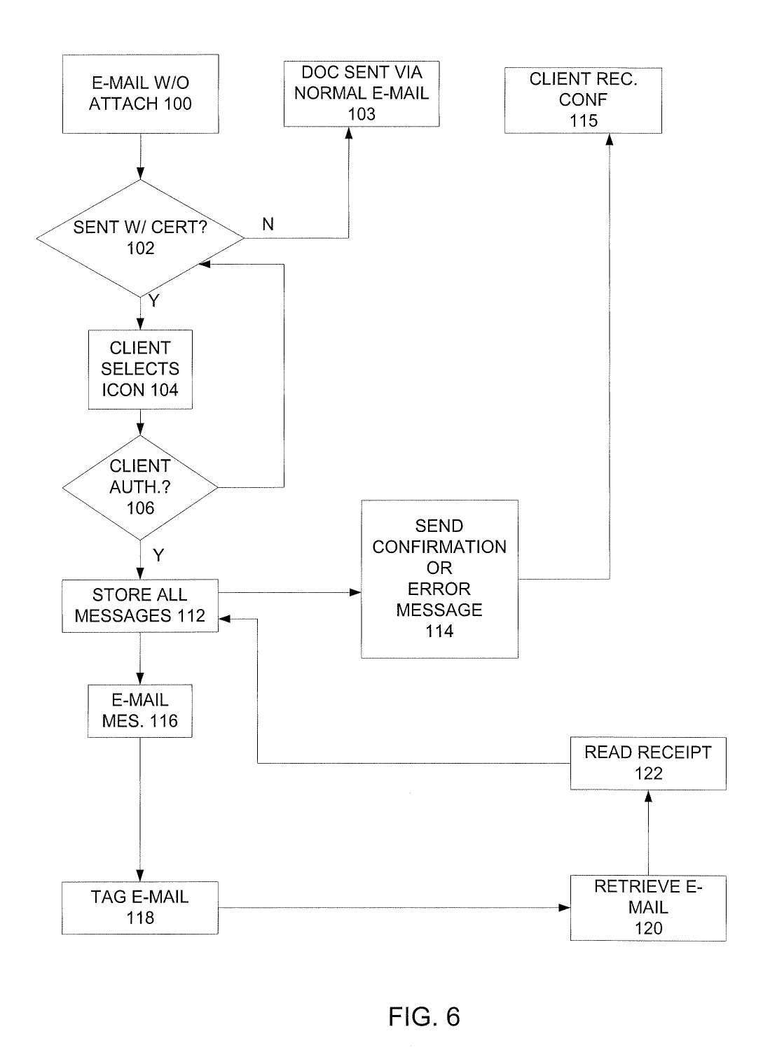

FIG. 7 shows details of how a client signs up to become part of the authentication site. In step 200 the client requests certification for a document as mentioned above. In step 202 the site checks if the client is registered or new. If new, in step 204 the client is forwarded to sign up page where relevant information is collected. In step 206 the client logs on. In step 208 the certification transaction is initiated. In step 210 the transaction is priced. In step 212 the relevant document is authenticated. If the document cannot be authenticated, the process is cancelled (step 214).

In step 216 the transaction is provided to the client for settlement. In step 218 a payment authorization process is started. In step 220 the cost of authentication is presented to the client's credit card or other payment source. In step 222 a credit card authorization is processed, the client is billed (step 224) and the authentication site is issued a payment (step 226). In step 228 client billing details are collected and stored and used later for reports.

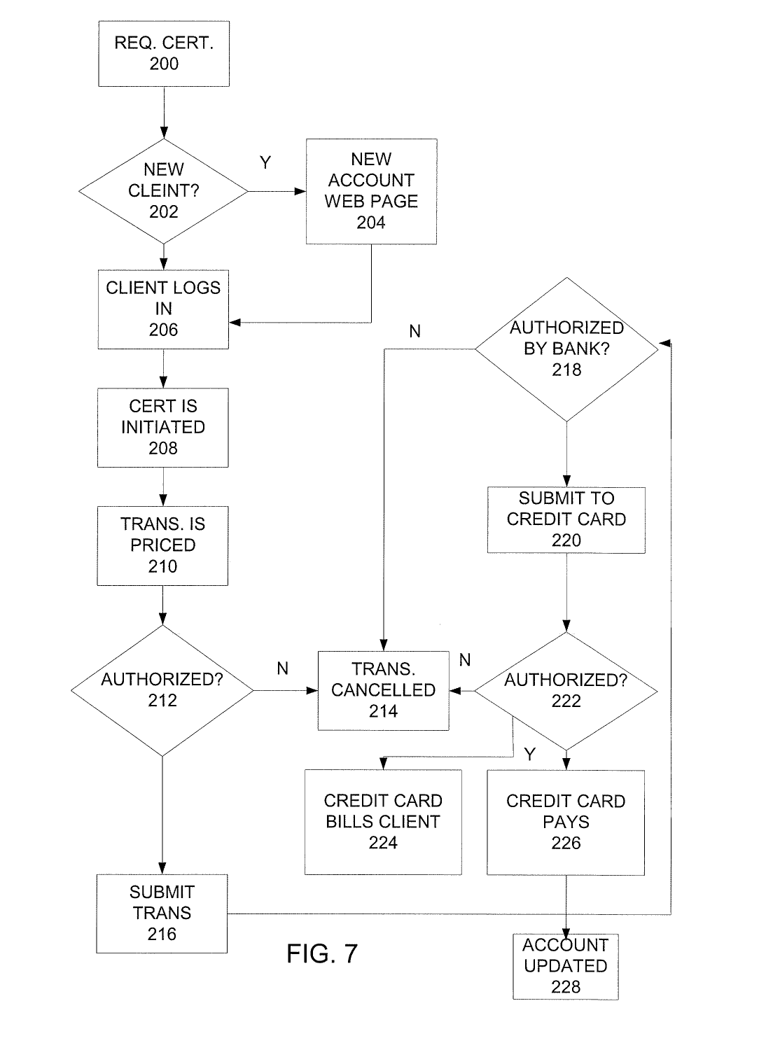

In the embodiment of FIG. 2, an e-mail is processed that is generated on PC 12 or laptop 14. In the alternate embodiment of FIG. 8 a web-based application is disclosed. In this application in step 99 the client accesses a remote website 25and generates an e-mail with or without attachments. The resultant e-mail is then processed as shown.

In the embodiments discussed so far, for every transaction a client is presented with a certification cost, and he then makes a decision on whether he wants to proceed or not. However, in many instances, the client knows what the costs are ahead of time and he takes these costs into consideration when he initially requests certification. In other instances, certification is crucial and therefore the costs may not been important when compared to the value associated with the transaction. For these kinds of transaction, the cost calculation and presentation thereof to the client may be omitted. FIG. 6 shows a flow chart for the certification of an e-mail message without cost calculation. Other transactions may be certified in a similar manner.

FIG. 7 shows a flow chart for a determining document certification costs for a client on a regular basis and charging the costs to the client.

It is clear from the above discussions that the novel document certification system and method described herein relies heavily on Internet communications between various parties. Therefore the system may be implemented very effectively into the system of an ISP provider. FIG. 8 shows a flow chart for implementing the certification as part of an ISP system and operation.

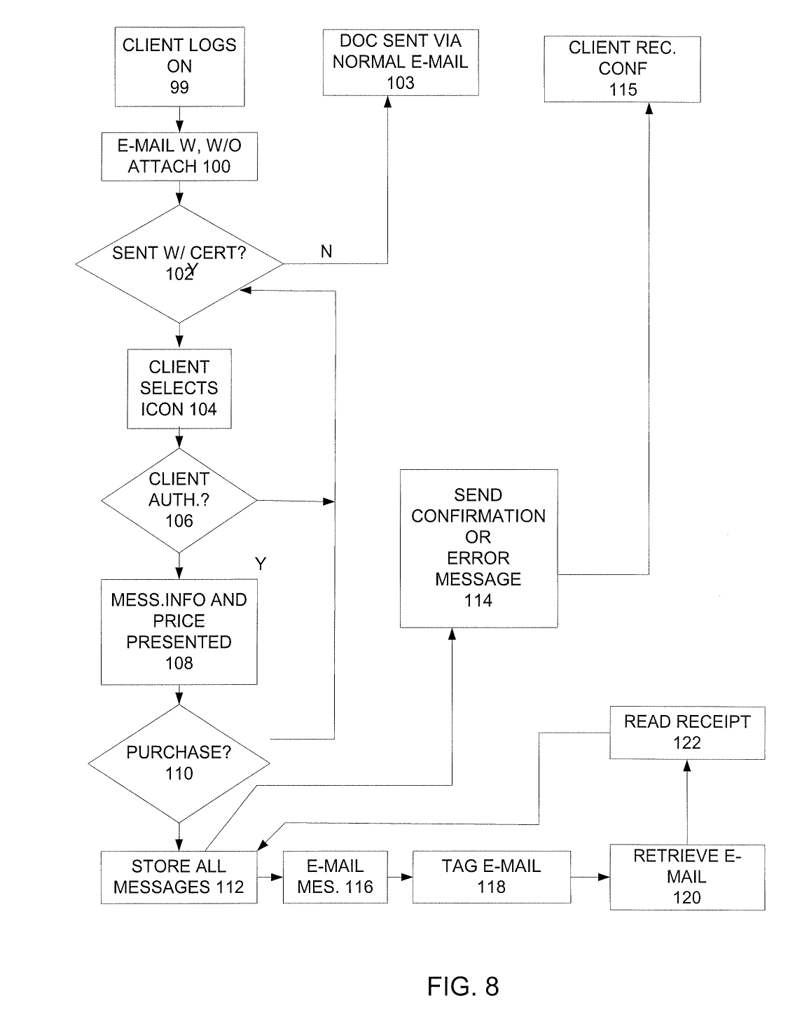

In the transactions discussed above, a certified communication is exchanged essentially between two parties. The same, or a very similar system can be used to send a communication to several recipients. However, if the number of recipients is large, the process could become too complicated. Therefore an alternative way of distributing the document to many recipients involves posting the document on a website and e-mailing the recipients a message indicating that the document has been posted. Each recipient is also provided with a public encryption key. When a recipient signs on the web page to access the document, the event is noted and used to generate a certification for said recipient. FIG. 9 shows a flow chart implementing this concept. In step 240 the client creates or scans a document. In step 242 the client logs onto the authentication site and selects a shared document icon on the site or uses other means to indicate that he wants to share a document. In step 244 the document is uploaded to the authentication site. In step 246 the site creates a record of the document. In step 248 the client provides a list of the recipients including their e-mail addresses. In step 250 an e-mail is sent to the intended recipients together with a link indicating where the document is stored and a public encryption key. Preferably the document is read-only so that the recipients can't change it. In step 252 one of the recipients opens the e-mail and accesses the site where the document is stored. The authentication server in step 254 authenticates the public key, records the e-mail of the recipient and access time and provides access to the document. This record is available to the client.

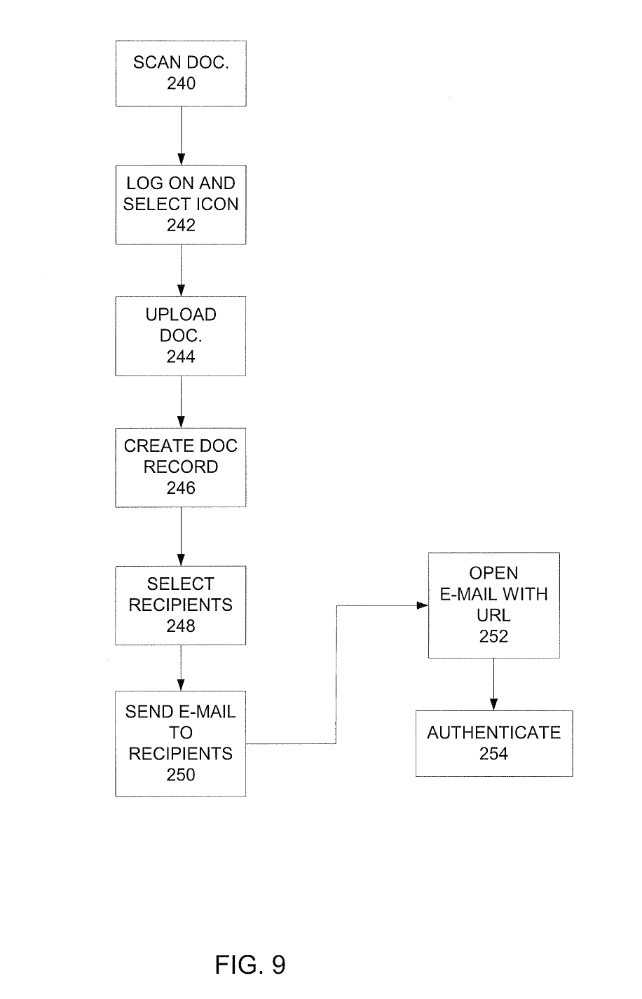

In some instances it may be desirable to add another layer of security on the process by providing a digital signature for both the client (sender) and the recipient of a document. FIG. 10 shows how the process is performed when digital signatures are provided. In step 118A the authentication site generates a copy of the e-mail to the client and the recipient. As part of this process, the client's private key is used to encrypt the message and a public key is added to the encrypted message. The public key provides a digital assurance that the message was not altered in transit.

One of the purposes of the certification process is to provide comfort to both the sender (the client) and the recipient that a message has been properly delivered. However, as discussed above, certification is also important at a later date for various activities, such as audits, legal actions, etc. If a client needs a certified copy of a document he contacts the certification system and identifies the document. The document and its certification tags are stored on servers in an encoded read-only form so that they cannot be altered by the client, or anyone else.

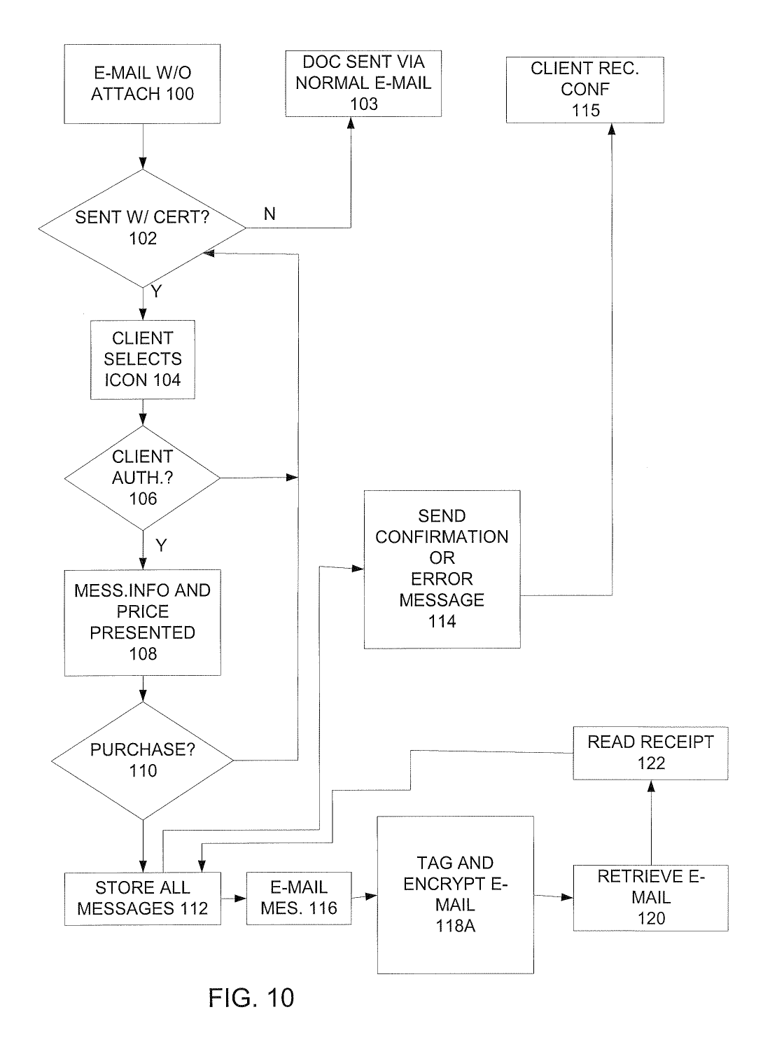

When the certification system gets a request for a document, the document and its tags are printed out, the document is reviewed and then a proper certification is attached thereto. The document is then mailed to the client or to a third party designated by the client. The process is illustrated by the flow chart of FIG. 11. In step 300 the client logs in and requests a copy of a document sent by any of the processes described above. In step 302 the requested document is displayed with associated information such as sender, recipient, subject matter, etc. In step 304 the client requests an additional or new authentication. In response, in step 306 the authentication site generates a message authentication algorithm to confirm that the message has not been altered or corrupted after it was initially recorded. Different algorithms may be used for this purpose. For example, an AUTHENTICATION KEY VALUE is calculated by using for example a checksum value of the original message in conjunction with other well-known criteria. This value is stored in the database when the message is originally sent. When a certification request is received the same criteria is applied to the checksum value of the stored message and compared to the original AUTHENTICATION KEY VALUE. If these values are identical the message is certified, if different the message is corrupt. If corrupt the system confirms the accuracy and remediate from backup if possible.

In step 308 a message is sent to the client indicating various information including the cost of such an additional or new authentication. In step 310 the clients accepts or rejects the transaction. If rejected, in step 314 the transaction is cancelled.

In step 316 the document is forwarded to a reviewer who reviews the document for authenticity, attaches tags to each page if necessary, and prints out the document. In step 318 the printed document is reviewed by an officer, notarized and sent my regular mail to the requester. It should be understood that the requester may be a sender, the recipient of the message or a third party authorized to obtain a certified/authenticated copy thereof.

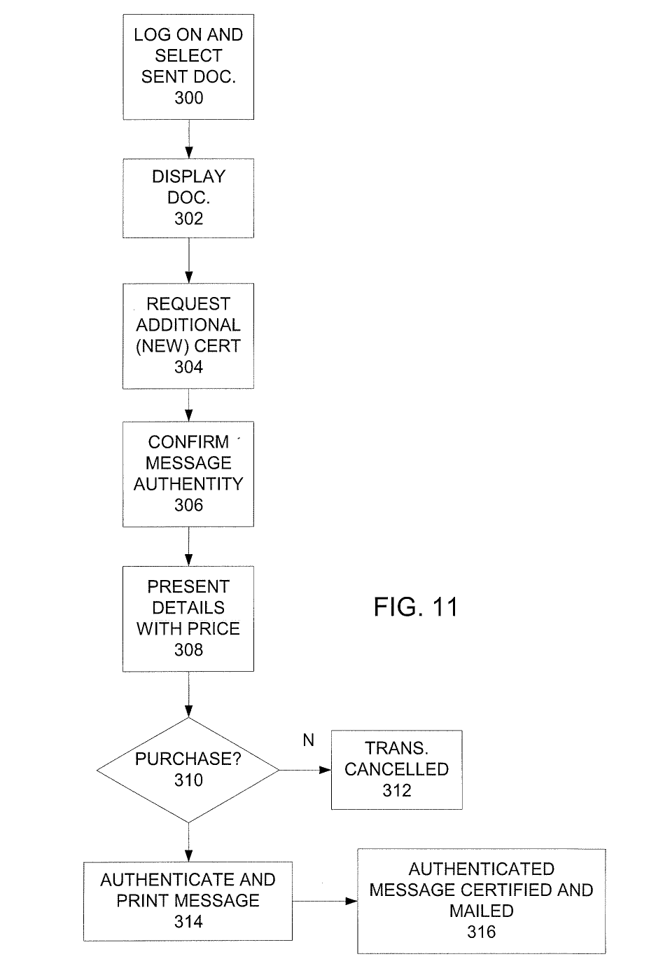

FIG. 12 shows a sample document that generated by the authentication site as described above.

Numerous modifications may be made to this invention without departing from its scope as defined in the appended claims.

We claim:

1. A system for authenticating documents comprising:
a receiving portal receiving a document;
a distributed network receiving said document and transmitting it to a recipient; and
an authenticating site coupled to said distributed network, said authenticating site performing an authenticating process on said document and generating a signal indicating whether said document is authentic or not.

2. The system of claim 1 wherein said document is one of a text file, an e-mail message, scanned document, paper document, and a fax.

3. The system of claim 1 wherein said authenticating site is adapted to send said tags to at least one of the sender and the receiver.

4. The system of claim 1 wherein said authenticating site includes a data storage element storing said document and the corresponding tags.

5. The system of claim 1 wherein said authenticating site is adapted to authenticate said document by checking the identity of the sender.

6. The system of claim 1 wherein said authenticating site is responsive to a request for a file descriptive of a previously stored document, said authenticating site providing a copy of said document in response to said request.

7. The system of claim 1 wherein said authenticating site is adapted to encrypt said document using a key.

8. A method of authenticating a document comprising:
receiving the document by an authentication site;
performing a test to determine if said document is genuine;
generating authenticating tags if said document is genuine;
transmitting said document to a recipient; and
transmitting said tags to one of the sender and recipient of said document.

9. The method of claim 8 wherein said tags are attached to the document before it is sent to the recipient and after received by receiver.

10. The method of claim 8 further comprising attaching a digital signature to said document.

11. The method of claim 8 wherein said document is sourced from a client and wherein said test includes checking if said client is a registered client.

12. The method of claim 8 wherein said step of authenticating is associated with a cost, further comprising determining said cost and presenting said cost to a client associated with said document.

13. The method of claim 12 further comprising providing a choice of generating said tags to said client after said cost is presented.

14. The method of claim 8 wherein said document is one of a text, scanned document, paper document, a fax and an e-mail.

15. The method of claim 8 wherein said document is stored at an authentication site.

16. The method of claim 15 wherein after said document is stored, several recipients receive e-mails indicating that the document is available for viewing.

17. The method of claim 16 wherein said document is stored as a read-only document.

18. The method of claim 8 wherein said test is selected to indicate that the contents of the document are accurate.
